(19) United States
(12) Patent Application Publication
(10) Pub. No.: US 2018/0168109 A1
(43) Pub. Date: Jun. 21, 2018

(54) Flower Pot

(71) Applicant: Yi Wang, Shenzhen (CN)

(72) Inventor: Yi Wang, Shenzhen (CN)

(21) Appl. No.: 15/584,407

(22) Filed: May 2, 2017

(30) Foreign Application Priority Data
Dec. 19, 2016 (CN) 201621395089.7

(51) Int. Cl. A01G 9/04; A01G 9/02

(52) U.S. Cl. CPC A01G 9/042; A01G 9/021

(57) ABSTRACT

A flower pot includes a main body and a water collection basin. The main body has a receiving cavity and at least one opening formed on a bottom portion thereof. The opening communicates the receiving cavity with an exterior of the main body. The water collection basin is formed underneath the main body, and is integrally extended from the bottom portion of the main body to act as a base for the flower pot.

### BACKGROUND OF THE PRESENT INVENTION

### Field of Invention

The present invention relates to a pot, and more particularly to a flower pot having a pot body and a supporting basin which is integrally connected to the pot body so as to form an entire integral structure of the pot. Thirty

### Description of Related Arts

Flower pots are utilized for growing plants and fruits. Conventional flower pots are usually made of plastic materials, ceramic materials or stone materials. A typical flower pot usually comprises a main body having a receiving cavity, and a supporting basin located underneath the main body. The main body has an opening which communicates the receiving cavity with an exterior of the main body. Excess water stored in the receiving cavity may be drained out of the main body through the opening. Excess water may then be collected by the supporting basin.

For the majority of flower pots, the main body and the supporting basin are two separate components so that they are extremely inconvenient to transport and to carry. When the flower pots are made of fragile materials such as glass or ceramic, the supporting basin may be broken very easily.

In order to connect the main body and the supporting basin when in transport and in actual use, one may separately produce the main body and the supporting basin and attach the two components together by glues or mechanical connectors (such as screws). The problem with this is that the main body and the supporting basin must be separately manufactured and attached with each other. This inevitably increases the manufacturing and transportation costs of the flower pots. Moreover, when either one component of the flower pot is defective, the other component cannot be individually used or sold.

As a result, there is a need to develop a flower pot which has a one-piece integral body and may be manufactured by simple processes.

### SUMMARY OF THE PRESENT INVENTION

Certain variations of the present invention provide a flower pot having a pot body and a supporting basin which is integrally connected to the pot body so as to form an entire integral structure of the pot.

Certain variations of the present invention provide a flower pot which comprises a main body and a supporting basin which may be manufactured by a single injection molding process. In other words, the present invention does not involve manufacturing of separate components which are later assembled together.

In one aspect of the present invention, it provides a flower pot, comprising:

a main body having a receiving cavity and at least one opening formed on a bottom portion thereof, the opening communicating the receiving cavity with an exterior of the main body; and

a water collection basin formed underneath the main body, the water collection basin being integrally extended from the bottom portion of the main body to act as a base for the flower pot.

This summary presented above is provided merely to introduce certain concepts and not to identify any key or essential features of the claimed subject matter.

### BRIEF DESCRIPTION OF THE DRAWINGS

FIG. 1 is a schematic diagram of a flower pot according to a preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

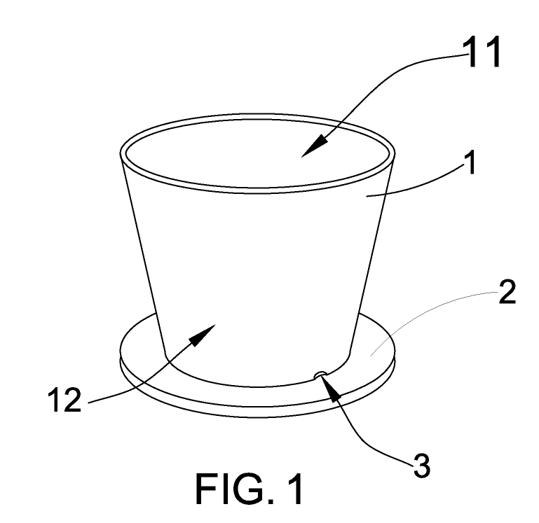

Referring to FIG. 1 of the drawings, a schematic diagram of a flower pot according to a preferred embodiment of the present invention is illustrated. Broadly, a flower pot may comprise a main body 1 and a water collection basin 2.

The main body 1 may have a receiving cavity 11 and at least one opening 3 formed on a bottom portion 12 thereof. The opening 3 may communicate the receiving cavity 11 with an exterior of the main body 1.

The water collection basin 2 may be formed underneath the main body 1. The water collection basin 2 may be integrally extended from the bottom portion 12 of the main body 1 to act as a base for the flower pot.

According to the preferred embodiment of the present invention, the flower pot may be manufactured from plastic material. Hence, the entire flower pot may be manufactured by plastic injection molding without separately manufacturing the main body 1 and the water collection basin 2. The main body 1 and the water collection basin 2 may form as an integral body so that the entire flower pot may be handled and transported together. The flower pot of the present invention may contain items other than flowers. For example, the flower pot of may be used to grow leaves, bamboo, or other varieties of plants. A predetermined amount of soil may also be stored in the flower pot for the purpose of growing the plant.

The main body 1 may be configured or made from plastic material. The main body 1 may be configured to have a circular cross section. The opening 3 may be formed at the bottom portion 12 of the main body 1 at a position in the vicinity of the boundary between the main body 1 and the water collection basin 2. In the preferred embodiment, the main body 1 may have a plurality of openings 3 formed at the bottom portion 12 of the main body 1 at a position in the vicinity of the boundary between the main body 1 and the water collection basin 2, so that excessive water received in the receiving cavity 11 may be discharged out of the main body 1 through the openings 3. The water may then be collected in the water collection basin 2. Excessive water stored in the water collection basin 2 may be re-absorbed back to the main body when the soil stored in the receiving cavity 11 becomes too dry.

The water collection basin 2 may also be configured from or made of plastic material (preferably the same material used for forming the main body 1). The main body 1 and the water collection basin 2 may be manufactured by plastic injection molding by using a predetermined mold so that a single molding process may produce the entire flower pot comprising the main body 1 and the water collection basin 2. The main body 1 and the water collection basin 2 form an integral body and cannot be separated. As such, the entire flower pot which comprises the main body 1 and the water collection basin 2 may be handled and transported very easily and conveniently.

The water collection basin 2 may also have a circular cross section wherein a diameter of the water collection basin 2 may be greater than that of the main body 1. Thus, the water collection basin 2 may act as an enlarged base for the flower pot.

The advantageous effect of the present invention may include simplifying the manufacturing steps of the flower pot. The main body 1 and the water collection basin 2 may be handled and transported as a single unit without the inconvenience and difficulty mentioned in the Description of Related Arts section above. Moreover, the manufacturing costs of the present invention will be substantially lowered when compared with conventional plastic flower pot in which the main body is separately manufactured from the supporting basin.

The present invention, while illustrated and described in terms of a preferred embodiment and several alternatives, is not limited to the particular description contained in this specification. Additional alternative or equivalent components could also be used to practice the present invention.

What is claimed is:

1. A flower pot, comprising:
a main body having a receiving cavity and at least one opening formed on a bottom portion thereof, said opening communicating said receiving cavity with an exterior of said main body; and
a water collection basin formed underneath said main body, said water collection basin being integrally extended from said bottom portion of said main body to act as a base for said flower pot.

2. The flower pot, as recited in claim 1, wherein said main body further comprises a plurality of openings formed at said bottom portion of said main body at a position in a vicinity of a boundary between said main body and said water collection basin.

3. The flower pot, as recited in claim 2, wherein said main body and said water collection basin are made from plastic material.

4. The flower pot, as recited in claim 3, being manufactured by plastic injection molding.
